(19) United States
(12) Patent Application Publication
(10) Pub. No.: US 2004/0058128 A1
(43) Pub. Date: Mar. 25, 2004

(54) Flexible display panel for application to vehicular or pedestrian surface

(76) Inventor: Barry David Pacey, North Yorkshire (GB)

Correspondence Address: Dickstein Shapiro, Morin & Oshinsky, 2101 L Street NW, Washington, DC, 20037-1526, US

(21) Appl. No.: 10/415,593

(22) PCT Filed: Oct. 26, 2001
(86) PCT No.: PCT/GB01/04754

(30) Foreign Application Priority Data
Oct. 30, 2000 (GB) 0026508.2

(51) Int. Cl. B32B 1/00

(52) U.S. Cl. 428/143

(57) ABSTRACT

A layered structure for providing an image on a desired surface comprises a backing substrate layer carrying an image, on optional protective coating over the image and a material with adhesive properties for adhering the backing substrate layer to the surface. The material with adhesive properties may be an adhesive such as a bituminuous compound, pressure sensitive adhesive, a thermoplastic material or a curable composition.

According to the invention there is provided a flexible display panel (image) for application to a vehicular or pedestrian surface said panel being formed by a laminated assembly, which comprises.

a fibrous backing layer which is capable of carrying a printed image in order to display any required visual material;

a foundation layer united with the backing layer and constituted in such a way that the foundation can adhere the display panel to a concrete or other vehicular or pedestrian surface upon application of a downward pressure to the display panel; and

a transparent wear and weather resistant top coating layer applied to the upper surface of the backing layer in order to protect the backing layer while rendering visible the printed material on the backing layer.

A flexible display panel according to the invention may therefore be printed with any required visual material or information on the upper surface of the fibrous backing layer, and the underlying foundation layer protects the underside of the backing layer while at the same time serving as the sole constituent of the panel, which is utilised to adhere the panel to a concrete or other surface.

With regard to the upper surface of the backing layer, the overlying coating layer protects the backing layer from ambient weather conditions, and also renders the panel resistant to wear damage from vehicle wheels or foot traffic, but the cover layer is transparent so that the printed material remains visible.

Preferably to provide visually distinctive advertising or other material, the fibrous backing layer is capable of receiving, and holding substantially permanently, a digital or printed image.

The foundation layer is preferably a bituminous layer, in the sense that is made of, or includes bitumen, or bitumen-like material (or is adhesively based), and which will preferably be treated in such a way that, in relation to prevailing ambient temperature and conditions, the foundation layer is capable of adhering to the support surface, by diffusion or otherwise, following application of downward pressure e.g. using a heavy roller, to the upper surface of the panel. In addition, the panel should be able thereafter to be capable of remaining adhesively united to or with the support surface, while being exposed to the ambient temperatures. In other words, different pre-treatment of the bituminous or adhesive layer will take place according to the anticipated range of ambient temperatures in the intended place of use. As an alternative material for the foundation layer is any suitable adhesive material.

In some circumstances, it may be desirable to apply a primer to the support surface and/or to the underside of the foundation layer, to improve adhesion, where necessary, to the support surface.

The backing layer is preferably a woven layer of natural and/or synthetic fibres, and optionally with integration of paper compounds.

1. A layered structure for providing an image on a desired surface comprising:
(i) a backing substrate layer
(ii) an image applied to an upper surface of the backing layer
(iii) a layer comprising a material with adhesive properties for adhering the lower surface of the backing layer to the said desired surface.

2. A structure as claimed in claim 1 further comprising transparent top coating applied over the image.

3. A structure as claimed in claim 2 wherein the protective transparent top coating includes particles of anti-slip aggregates.

4. A structure as claimed in claim 2 or 3 wherein the protective transparent top coating includes one or more materials selected from glass beads, clear silica beads and opalescent sand.

5. A structure as claimed in any proceeding claim wherein the image is a printed image.

6. A structure as claimed in claim 5 wherein the image is printed directly onto the backing substrate layer.

7. A structure as claimed in claim 5 wherein the image is printed onto a substrate, which substrate is applied to the backing layer.

8. A structure as claimed in any preceding claim wherein the backing substrate layer comprises a mesh fabric.

9. A structure as claimed in any preceding claim wherein the layer of material with adhesive properties is an adhesive, especially a pressure sensitive adhesive.

10. A structure as claimed in any preceding claim wherein the layer of material with adhesive properties comprises a bituminous adhesive layer.

11. A structure as claimed in 10 wherein the bituminous adhesive layer is a glass fibre reinforced bituminous adhesive layer.

12. A structure as claimed in any of claims 1 to 8 wherein the layer of material with adhesive properties comprises a high-tack thermoplastic material.

13. A structure as claimed in any of claims 1 to 8 wherein the layer of material with adhesive properties comprises a liquid composition, which is cured at the site of application.

14. A structure as claimed in any of claims 2 to 8 or claim 13 wherein the protective coating and the material with adhesive properties comprise essentially the same material, whereby the image and backing layer are encapsulated.

15. A method of applying an image structure to a desired surface comprising the steps of:
(a) providing a layered image structure comprising
(i) a backing substrate layer
(ii) an image applied to an upper surface of the backing layer; and
(iii) an adhesive layer applied to the lower surface of the backing layer;
(b) heating the adhesive layer; and
(c) applying the layered image structure to the desired surface.

16. A method of applying an image structure to a desired surface comprising the steps of:
(a) providing a layered structure comprising
(i) a backing substrate layer; and
(ii) an image applied to an upper surface of the backing layer;
(b) applying a layer comprising a material with adhesive properties to the desired surface; and
(c) applying the layered image structure to the adhesive material.

17. A method as claimed in claim 16 wherein the layer comprising a material with adhesive properties comprises a high-tack thermoplastic material.

18. A method as claimed in claim 16 wherein the layer comprising a material with adhesive properties comprises a material, which is cured at the site of application.

19. A method as claimed in claim 16 or 18 including the step of curing the adhesive material.

20. A method as claimed in any of claims 15 to 19 wherein the image comprises a printed image.

21. A method as claimed in any of claims 15 to 20 wherein the backing substrate layer comprises a mesh fabric.

22. A method as claimed in any of claims 15 to 21 including the steps of applying a protective transparent top coating over the image.

23. A system for applying an image to a desired surface comprising:
(a) a layered image structure comprising
(i) a backing substrate layer; and
(ii) an image applied to a surface of the backing layer; and
(b) a quantity of adhesive material, for application to the backing substrate layer and/or the desired surface, sufficient for adhering the backing substrate layer to the surface.

24. A system as claimed in claim 23 wherein the image is a printed image.

25. A system as claimed in 23 or 24 wherein the backing substrate layer comprises a mesh fabric.

26. A system as claimed in any of claims 23 to 25 wherein the layered structure further comprises a protective transparent top coating applied to the image.

27. A system as claimed in any of claims 23 to 26 wherein the adhesive material is in the form of curable composition.

28. A system as claimed in claim 27 wherein the adhesive material is a two-component system and the components are mixed to initiate curing.

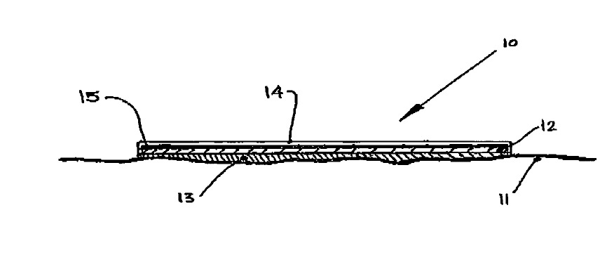

29. A layered image structure substantially as hereinbefore described with reference to FIG. 1.

30. A method as claimed in any of claims 15 to 22 substantially as hereinbefore described.
